(19) United States
(12) Patent Application Publication
(10) Pub. No.: US 2015/0267045 A1
(43) Pub. Date: Sep. 24, 2015

(54) POLYMERIC COMPOSITE MATERIAL AND METHOD OF PREPARING THE SAME

(71) Applicant: SUNKO INK CO., LTD., Taichung City (TW)

(72) Inventors: YI-JUNG HUANG, Taichung (TW); TING-KAI HUANG, Taichung (TW); HSIN-HUNG LIN, Tainan (TW); CHIA-PANG LIU, Taichung (TW); I-CHI CHEN, Taichung (TW); CHOU-POU HSIEH, Taichung (TW)

(73) Assignee: SUNKO INK CO., LTD., Taichung City (TW)

(21) Appl. No.: 14/220,931

(22) Filed: Mar. 20, 2014

(51) Int. Cl. C08L 23/16; C08L 9/06; C08L 7/00; C08L 33/10; B29B 9/12; C08L 75/04

(52) U.S. Cl. CPC C08L 23/16; B29B 9/12; C08L 75/04; C08L 7/00; C08L 33/10; C08L 9/06; B29L 2031/772

(57) ABSTRACT

A polymeric composite material includes a plurality of polymer bases, at least one of which is a rubber base, and a filler. The filler is blended with the rubber base, which in turn is blended with other of the polymer bases. As a result, the rubber base is a medium to let the filler uniformly distributed in the polymer bases.

### BACKGROUND OF THE INVENTION

1. Technical Field

The present invention relates to a polymeric material, and more particularly to a polymeric composite material, and a method of preparing the same.

2. Description of Related Art

Polymeric materials have been traditionally used in applications such as plastic, rubber, fiber, tire, coating material, adhesive, and synthetic leather for their superior mechanical and chemical properties. Recent development in polymer technology has allowed the tailoring of polymer materials with unique features and broadened the usage to fabrics, architecture, transportation, communication, electronics, biotech, and aeronautics.

In recent years, the demands for materials with versatile functionalities are increasing. The use of traditional mono-homopolymer or copolymer alone could no longer meet the multiple facets of different fields. An approach to enhance the practicality of polymeric materials is to blend polymers into polymeric composites in order to acquire the unique properties from each of the constituents.

However, even composite materials could not completely alleviate the demands. The incompatibility between polymers often renders the composites with less than satisfactory physical and chemical properties. In addition, the preparation processes are usually time and money consuming. Therefore, it is imperative to develop a method to resolve the issue of incompatibility and production difficulty.

### BRIEF SUMMARY OF THE INVENTION

In view of the above, the primary objective of the present invention is to provide a polymeric composite material with superior physical and chemical properties.

The secondary objective of the present invention is to provide a facile and simple method to prepare the polymeric composite material.

In order to achieve the aforementioned objective, the present invention provides a polymeric composite material, which includes a plurality of polymer bases, at least one of which is a rubber base, and a filler distributed in the polymer bases.

The present invention further provides a polymeric composite material including a plurality of polymer bases, at least one of which is a rubber base, and a filler. The filler is blended with the rubber base, which in turn is blended with other of the polymer bases.

The present invention further provides a method of preparing a polymeric composite material, including the following steps:

A. Blend a filler with a rubber base to absorb the filler in the rubber base; and

B. Blend the rubber base with polymer bases to offer uniform distribution of the filler in the polymer bases.

With such design, the present invention provides the rubber base to serve as a medium. The filler is absorbed by the rubber base, which in turn is blended with the polymer to afford a uniform distribution of the filler in the polymer base. Such an approach enhances the properties of the polymeric composite material and provides a facile and simple way for manufacturing the material.

### DETAILED DESCRIPTION OF THE INVENTION

The detailed description and technical contents of the present invention will be explained with the following examples.

### Example 1

### Lightweight Polyurethane Polymeric Composite Material

Materials for preparing the polyurethane polymer of the example 1 include ethylene-propylene-diene monomer (EPDM) rubber (1,193 grams), cork (1,193 grams), and polyurethane resin (1,590 grams). A shore hardness of the polyurethane resin is 85 A, and a specific gravity is about 1.3. First, the EPDM rubber and the cork are blended in a mixer (not shown) at 150 rpm and room temperature. After an hour, the cork is uniformly absorbed by the EPDM rubber. Next, the polyurethane resin is added into the mixer. The mixer is running at the same speed (150 rpm) for another hour to obtain an intermediate product. The intermediate product is then transferred to a single screw extruder (not shown) for granulation at 180° C. and with a screw speed of 70 rpm to afford the polyurethane polymeric composite material in pellets. The material has a shore hardness of 65 A and a specific gravity of 1.0.

In the example 1, a filler (the cork) is uniformly distributed in a polymer base (the polyurethane resin) by the participation of a rubber base (the EPDM rubber) to produce the polyurethane polymeric composite material, which is lightweight and has a high workability. More specifically, the rubber base could be seen as a kind of polymer bases.

### Example 2

### Lightweight Polyurethane Polymeric Composite Material

Materials used in the example 2 are basically the same as the example 1, except that the example 2 prepares the polyurethane polymeric composite material without a polymerized polymer base itself, but with its corresponding monomers and corresponding initiators instead. For example, the corresponding monomers and the corresponding initiators of polyurethane, which are methylene diphenyl diisocyanate (MDI), and polybutylene adipate and butanediol, respectively, are selected in the example 2 as polymer bases. It should be noted that any monomer having isocyanate, such as toluene diisocyanate and hexamethylene diisocyanate, and any initiator having polyalcohol, such as all kinds of commonly used polyether polyol and polyester polyol, could be used as the monomers and the initiators in other embodiments.

In the process of preparing the polyurethane polymeric composite material of the example 2, the materials include polybutylene adipate (1,000 grams), butanediol (90 grams), MDI (500 grams), EPDM rubber (1,193 grams), and cork (1,193 grams).

In the beginning, the polybutylene adipate, the butanediol, the EPDM rubber, and the cork are blended in a mixer (not shown) at 150 rpm for an hour, and then the MDI is added in the mixer for blending at the same speed for 30 second. After that, the mixture in the mixer is taken out and left standing for a day to obtain an intermediate product. Finally, the intermediate product is broken into pieces to be transferred to a single screw extruder (not shown) for granulation at the same temperature and with the same screw speed as the example 1 to afford the polyurethane polymeric composite material in pellets. The property of the polyurethane polymeric composite material of the example 2 is similar to the example 1, which is lightweight and has a high workability. It should be noted that polymerization happens during the process, and therefore in addition to polymerized polymer bases, there could also be monomers of the unreacted or partially reacted polymer bases and/or prepolymers thereof, and initiators of the unreacted or partially reacted polymer bases and/or prepolymers thereof.

### Example 3

### Lightweight Polyurethane Polymeric Composite Material

Materials used in the example 3 are basically the same as the examples 1 and 2, except that polybutylene adipate is replaced by one of its monomers, which is adipic acid. Furthermore, polymerization of polybutylene adipate happens during the process of preparing the polymeric composite material in the example 3 by involving dibutyltin oxide, phosphorous acid, and chain extender, such as adipoyl biscaprolactam, into the process.

The materials include polybutylene adipate (658 grams), butanediol (495 grams), and cork (1,193 grams), which are previously blended with each other for polymerization of polybutylene adipate (in the same way of mentioned above) to uniformly distribute the cork in the polybutylene adipate. Then, EPDM rubber (1,193 grams) and MDI (500 grams) are added into a mixer (not shown) for blending under the same conditions as mentioned above. The following procedures are the same as the example 2 for obtaining the lightweight polyurethane polymeric composite material. Similarly, the polyurethane polymeric composite material of example 3 could contain corresponding monomers of initiators of polymeric resin and/or prepolymers of the monomers, such as adipic acid and oligomers of polybutylene adipate.

### Example 4

### Polyurethane Polymeric Composite Material of High Fluidity

The details of the example 4 are basically the same as the example 1, except that the cork is replaced by rubber powder recycled from waste tires.

First, EPDM rubber (795 grams) and the rubber powder (795 grams) are blended in a mixer (not shown) at 150 rpm and room temperature. After an hour, the rubber powder will be uniformly absorbed by the EPDM rubber. Next, polyurethane (1,590 grams) is added in the mixer, wherein the polyurethane has a melt flow index (MI index) lower than 2.6 g/10 min at 190° C. and 8.7 kg, and a shore hardness of 85 A. After blending for another hour, an intermediate product is obtained. The intermediate product is then transferred to a single screw extruder (not shown) for granulation at 180° C. and with a screw speed of 70 rpm to afford the polyurethane polymeric composite material in pellets with a high fluidity (by measurement, about 12.0 g/10 min at 190° C. and 8.7 kilograms). In other words, the fluidity of the polyurethane polymeric composite material is improved. By the way, the shore hardness is slightly reduced to 75 A as well.

It can be seen that the rubber base (the EPDM rubber) is helpful for uniform distribution of the filler (the rubber powder recycled from waste tires) in the polymer base (the polyurethane). As a result, the polymeric composite material has a high fluidity and a high workability. Besides, the shore hardness of the composite material could be reduced too. In other embodiments, the corresponding monomers and initiators of polymer bases could be added instead.

### Example 5

### Polyurethane Polymeric Composite Material of Anti-Skid, Shorter Time for Molding, and High Wear Resistance

The details of the example 5 are basically the same as the example 4, except that the filler further includes natural graphite powder.

First, natural rubber (84 grams), rubber powder recycled from waste tires (84 grams), and the natural graphite powder (795 grams) are blended in a mixer (not shown) at 150 rpm and room temperature. After an hour, the graphite powder and the rubber power will be uniformly absorbed by the natural rubber. Next, polyurethane (1,590 grams) is added into the mixer for another hour of blending (150 rpm) to obtain an intermediate product. The intermediate product is then transferred to a single screw extruder (not shown) for granulation at 180° C. and with a screw speed of 70 rpm to afford the polyurethane polymeric composite material in pellets. By measurements, it takes 36 seconds to mold single polyurethane, while the polyurethane polymeric composite material of the example 5 only takes 22 seconds to be molded with the same process. Besides, the rubber powder recycled from waste tire further provides better anti-skid performance. It is shown that a driving force of the polyurethane polymeric composite material during a following injection molding process increases from 0.75 kg to 1.2 kg. As to the natural rubber, it is helpful to improve wear resistance from 62.3 mm³ to 52.0 mm³.

In the aforementioned examples, the polymer bases are polyurethane, and it is easy to understand that the polymer base may be selected from any polymer depending on the requirements of what the polymeric composite material is going to be made into. Based on the properties of molding, the polymer bases may be selected from thermoplastic resin or thermosetting resin. For the former, it could be polyethylene (PE), polypropylene (PP), polyvinylchloride (PVC), polystyrene (PS), acrylonitrile butadiene styrene (ABS), polymethacrylate, and thermoplastic polyurethane (TPU); and for the latter, it could be phenolic resin, polyurethane resin, epoxy, and unsaturated polyester resin. Based on the structure of main chain of the polymer, the polymer bases may be selected from polyolefin resin, styrenic resin, vinyl resin, polyurethane resin, silicone resin, and fluorine resin, etc. Therefore, the selection of the polymer bases is not a limitation, and corresponding monomers and initiators could be selected too. Here we are going to select anther polymer base as examples.

### Example 6

### Lightweight Polymethacrylate Polymeric Composite Material

The details of the example 6 are basically the same as the example 1, except that polyurethane is replaced by polymethacrylate as the polymer bases, and the kinds of the rubber base are replaced too.

First, similar to the example 1, styrene isoprene rubber (1,193 grams) and cork (1,193 grams) are blended in a mixer at 150 rpm and room temperature for an hour to let the cork be uniformly absorbed by the styrene isoprene rubber. Next, polymethacrylate (1,590 grams) is added into the mixer for blending for another hour, wherein a shore hardness of the polymethacrylate is 64D, and a specific weight of which is 1.2. Finally, an intermediate product is obtained in this way, and the intermediate product is then transferred to a single screw extruder (not shown) for granulation at 140° C. and with a screw speed of 70 rpm to afford the lightweight polymethacrylate polymeric composite material in pellets. A shore hardness of the polymethacrylate polymeric composite material of the example 6 is 98 A, and a specific weight is lowered to 0.95, which satisfies the requirements of lightweight and high workability.

### Example 7

### Lightweight Polymethacrylate Polymeric Composite Material

Materials used in the example 7 are basically the same as the example 6, except that the example 7 prepares the polymethacrylate polymeric composite material without a polymerized polymer base itself, but with its corresponding monomers and corresponding initiators instead. For example, the corresponding monomers and the corresponding initiators of polymethacrylate, which are methylmethacrylate (MMA) and commonly used polymerization initiators, respectively, are selected in the example 7 as polymer bases. Besides, the EPDM rubber is replaced by natural rubber.

First, the MMA (1,590 grams), the natural rubber (1,193 grams), cork (1,193 grams), and a polymerization initiator (3 grams) are blended in a mixer at room temperature and 150 rpm for an hour, and then an obtained intermediate product is transferred to a single screw extruder for granulation at 140° C. and with a screw speed of 70 rpm to afford the polymethacrylate polymeric composite material in pellets. The properties of the composite material of the example 7 are similar to the example 6, which is lightweight.

### Example 8

### Polymethacrylate Polymeric Composite Material of Lightweight, Shorter Time for Molding, and High Wear Resistance

The details of the example 8 are basically the same as the example 6, except that two fillers are further added, which are rubber powder recycled from waste tire and graphite powder, in order to enhance fluidity and wear resistance. Furthermore, styrene butadiene rubber is used as the rubber base in the example 8.

First, the styrene butadiene rubber (80 grams), rubber powder recycled from waste tire (160 grams), cork (320 grams), and the graphite powder (80 grams) are blended in a mixer (room temperature and 150 rpm) for an hour to let the fillers be uniformly absorbed by the styrene butadiene rubber. Next, polymethacrylate (1,590 grams, with shore hardness of 64D and specific gravity of 1.2) is added into the mixer for blending for another hour with the same speed. Finally, an obtained intermediate product is transferred to a single screw extruder (140° C. and 70 rpm) for granulation to afford the polyurethane polymeric composite material in pellets. A shore hardness of the composite material of the example 8 is 55D, a specific gravity is 1.1, a MI index increases from 4.8 g/10 min to 25.6 g/10 min, and a wear resistance is improved from 62.3 mm³ to 58.7 mm³.

### Example 9

### Polymethacrylate Polymeric Composite Material of Lightweight, Shorter Time for Molding, and High Wear Resistance

The details of the example 9 are basically the same as the example 8, except that the filler further includes an inorganic foaming agent, and the rubber base is hydrogenated. More specifically, the inorganic foaming agent (10 grams) is blended with the other fillers and the hydrogenated styrene butadiene rubber to let these fillers (including the inorganic foaming agent) be uniformly absorbed by the rubber base. With the same procedures of blending and granulating as mentioned in the example 8, the polymethacrylate polymeric composite material is afforded in pellets. It is worth mentioning that a specific gravity of the polymeric composite material of the example 9 reduces to 0.5 because of adding the inorganic foaming agent; at the same time, a shore hardness reduces to 85 A, and a wear resistance increases to 23.6 mm³ as well.

### Example 10

### Polymethacrylate Polymeric Composite Material of UV-Resistance

The details of the example 10 are basically the same as the example 6, except that the cork is replaced by montmorillonite (MMT).

First, natural rubber (80 grams) and the MMT (80 grams) are blended in a mixer at room temperature and 150 rpm for blending for an hour to let the MMT be uniformly absorbed by the natural rubber. Next, polymethacrylate (1,590 grams, with a shore hardness of 64D and a specific gravity of 1.2) is added into the mixer to be blended for another hour (150 rpm). Finally, an obtained intermediate product is then transferred to a single screw extruder for granulation at 140° C. and with a screw speed of 70 rpm to afford the polyurethane polymeric composite material in pellets, which is UV-resistant. It is worth mentioning that the UV-resistance is enhanced because of adding the MMT. Specifically, a test specimen of the polymeric composite material of the example 10 is only slightly yellowed after exposure to 240 nm-300 nm UV light for four days. By the way, a shore hardness of the polyurethane polymeric composite material of the example 10 increases a little bit to 66D, and a specific gravity of which is slightly increased to 1.3.

The fillers selected in the preparing process will affect the properties of the prepared polymeric composite materials, and it should be understood that the fillers provided in the aforementioned examples are not the limitation of the present invention. Therefore, depending on required properties, the fillers could be selected from recycled polymer, recycled fibers, cork, rubber pellets, bamboo carbon, zeolite, foaming agent, wood powder, clay, chaff, bagasse, coffee grounds, tea leaves, newspapers, diatomite, ceramic powder, graphite powder, limestone, metal powder, and any combination of above. The aforementioned recycled polymer could be selected from rubber powder recycled from waste tires, polyethylene (PE), polyvinylchloride (PVC), polypropene (PP), polystyrene (PS), polyethylene terephthalate (PET), acrylic, fluorine plastic, polyimide (PI), polycarbonate (PC), nylon, ABS, and any combination of above.

The synthetic rubber mentioned in the aforementioned examples includes all kinds of commonly seen synthetic rubber and modified rubber, such as graft maleic anhydride. The synthetic rubber could be selected from polybutadiene (BR), styrene-butadiene rubber (SBR), nitrile butadiene rubber (NBR), chloroprene rubber (CR), buna rubber, ethylene-propylene rubber, polysulfide rubber, acrylic ester rubber, fluorine rubber, silicone rubber, butyl rubber (IIR), isoamyl rubber, ethylene-propylene-diene monomer (EPDM), styrene butadiene rubber (SBR), hydrogenated SBR, styrene ethylene/butylene styrene rubber (SEBS), styrene isoprene copolymer, and any combination of above.

The method of molding the polymeric composite materials of the present invention could be injection molding, die molding, and other conventional methods for molding polymeric composite materials.

In conclusion, the present invention provides the rubber base to be a medium to let the filler be uniformly absorbed by the rubber base, or to be a thickening dispersant to let the filler be uniformly distributed or integrated in the polymer base. As a result, the present invention may improve some properties of the polymeric composite materials and make them easier to be molded. Furthermore, some recycled materials may be incorporated in the present invention, which is helpful to environment protection.

It must be pointed out that the embodiments described above are only some preferred embodiments of the present invention. All equivalent structures which employ the concepts disclosed in this specification and the appended claims should fall within the scope of the present invention.

What is claimed is:

1. A polymeric composite material, comprising:
a plurality of polymer bases; and
a filler distributing in the polymer bases;
wherein at least one of the polymer bases is a rubber base;

2. The polymeric composite material of claim 1, wherein the polymer bases include at least one kind of resin and the rubber base.

3. The polymeric composite material of claim 2, wherein the resin includes polyurethane or polymethacrylate.

4. The polymeric composite material of claim 3, wherein the polyurethane is thermoplastic polyurethane.

5. The polymeric composite material of claim 2, further comprising corresponding monomers of the resin and/or prepolymers of the monomers, and corresponding initiators of the resin and/or prepolymers of the initiators.

6. The polymeric composite material of claim 5, wherein the resin is thermoplastic resin.

7. The polymeric composite material of claim 5, wherein the resin is thermosetting resin.

8. The polymeric composite material of claim 5, wherein the resin is selected from at least one of the group consisting of polyolefin resin, styrenic resin, vinyl resin, polyurethane resin, unsaturated polyester resin, epoxy resin, phenolic resin, urea-formaldehyde resin, and polymethacrylate.

9. The polymeric composite material of claim 5, wherein the resin includes polyurethane, the monomers include isocyanate, and the initiators include polyalcohol.

10. The polymeric composite material of claim 9, wherein the monomers include methylene diphenyl diisocyanate.

11. The polymeric composite material of claim 9, wherein the initiators include polybutylene adipate and butanediol.

12. The polymeric composite material of claim 11, wherein the initiators further include adipic acid.

13. The polymeric composite material of claim 5, further comprising methylmethacrylate monomer, wherein the resin includes polymethacrylate.

14. The polymeric composite material of claim 5, wherein the rubber base is made of natural rubber.

15. The polymeric composite material of claim 5, wherein the rubber base is made of synthetic rubber.

16. The polymeric composite material of claim 1, wherein the rubber base is selected from the group consisting of ethylene propylene rubber, styrene isoprene rubber, styrene butadiene rubber, and hydrogenated styrene butadiene rubber.

17. The polymeric composite material of claim 3, wherein the rubber base is selected from the group consisting of ethylene propylene rubber, styrene isoprene rubber, styrene butadiene rubber, and hydrogenated styrene butadiene rubber.

18. The polymeric composite material of claim 16, wherein the ethylene propylene rubber is ethylene-propylene-diene monomer rubber.

19. The polymeric composite material of claim 17, wherein the ethylene propylene rubber is ethylene-propylene-diene monomer rubber.

20. The polymeric composite material of claim 1, wherein the filler is selected from the group consisting of recycled polymer, recycled fibers, cork, rubber pellets, bamboo carbon, zeolite, wood powder, clay, chaff, bagasse, coffee grounds, tea leaves, news papers, diatomite, ceramic powder, graphite powder, limestone, and metal powder.

21. The polymeric composite material of claim 20, wherein the recycled polymer is selected from the group consisting of rubber powder of tire, polyethylene, polyvinylchloride, polypropene, polystyrene, polyethylene terephthalate, acrylic, fluorine plastic, polyimide, polycarbonate, nylon, and acrylonitrile butadiene styrene.

22. A polymeric composite material, comprising a plurality of polymer bases and a filler, wherein at least one of the polymer bases is a rubber base, and the filler is blended with the rubber base, which in turn is blended with other of the polymer bases.

23. The polymeric composite material of claim 22, wherein the polymer bases include at least one kind of resin and the rubber base.

24. The polymeric composite material of claim 23, further comprising corresponding monomers of the resin and/or prepolymers of the monomers, and corresponding initiators of the resin and/or prepolymers of the initiators, wherein the filler is previously blended with the monomers and/or the prepolymers of the monomers, and then is blended with the rubber base and the initiators and/or the prepolymers of the initiators, so that the monomers, the prepolymers of the monomers, the initiators, and the prepolymers of the initiators are polymerized, and the filler is uniformly distributed therein.

25. The polymeric composite material of claim 24, wherein the resin includes polymethacrylate, and the corresponding monomer is methylmethacrylate.

26. The polymeric composite material of claim 23, wherein further comprising corresponding monomers of the resin and/or prepolymers of the monomers, and corresponding initiators of the resin and/or prepolymers of the initiators, wherein the filler is previously blended with the initiators and/or the prepolymers of the initiators, and then is blended with the rubber base and the monomers and/or the prepolymers of the monomers, so that the monomer, the prepolymers of the monomers, the initiators, and the prepolymers of the initiators are polymerized, and the filler is uniformly distributed therein.

27. The polymeric composite material of claim 26, wherein the resin includes polyurethane, the monomers include isocyanate, and the initiators include polyalcohol.

28. The polymeric composite material of claim 27, wherein the polyurethane is thermoplastic polyurethane.

29. A method of preparing a polymeric composite material, comprising the steps of:
blending a filler with a rubber base to absorb the filler in the rubber base; and
blending the rubber base with polymer bases to offer an uniform distribution of the filler in the polymer bases.

30. The method of claim 29, further comprising the step of granulating a mixture of the filler, the rubber base, and the polymer bases.
